(19) United States
(12) Patent Application Publication
(10) Pub. No.: US 2005/0139130 A1
(43) Pub. Date: Jun. 30, 2005

(54) Cementitious composition

(76) Inventors: Emmett M. Partain III, Bound Brook, NJ (US); Pol C.A. Storme, Francois Van Impelaan (BE)

Correspondence Address: THE DOW CHEMICAL COMPANY;INTELLECTUAL PROPERTY SECTION, P. O. BOX 1967, MIDLAND, MI, 48641-1967, US

(21) Appl. No.: 10/511,029

(22) PCT Filed: Mar. 28, 2003
(86) PCT No.: PCT/US03/09694

(30) Foreign Application Priority Data
Jun. 12, 2002 (US) 60388416

(51) Int. Cl. C04B 14/00

(52) U.S. Cl. 106/730

(57) ABSTRACT

The curing time of cementitious cellulose ether comprising-compositions can be controlled by incorporation into the composition i) a cationically-modified or a secondary or tertiary amino-modified cellulose ether or ii) a cellulose ether comprising a hydroxyethoxyl substituent alone or in combination with one or more other substituents bound to oxygen, wherein the ethylene oxide molar substitution MS_{hydroxyethoxyl} is either from 2.2 to 3.2 and the percentage of unsubstituted anhydroglucose units is up to 8.5 percent or the ethylene oxide molar substitution MS_{hydroxyethoxyl} is less than 2.2 and the percentage of unsubstituted anhydroglucose units is up to 12 percent.

The present invention relates to cementitious compositions and to a method of controlling the curing time of cellulose ether-comprising cementitious compositions.

Cementitious compositions are used in various construction applications for example in casting, extruding or grout applications, as tape-joints, tile adhesives or oil well cementing slurries. Cellulose ethers are added to cementitious compositions for a variety of purposes.

U.S. Pat. No. 5,047,086 discloses cementitious compositions for extrusion which consist of cement mortar, crushed pulp fiber, and as a binder either an alkyl cellulose or alkyl hydroxyalkyl cellulose having a viscosity of 80,000 centipoise (cP) as a 2 weight percent aqueous solution.

Cellulose ethers such as hydroxyethyl cellulose are used as additives for conferring sag resistance to cementitious compositions for cast, trowel, and adhesive applications. Hydroxyethyl cellulose also serves as a fluid-loss additive in cementitious compositions, preventing loss of water to the substrate while the cementitious composition is curing. Hydroxyethyl cellulose is widely used as fluid loss additive in oil well cementing compositions. Cellulose ethers are also added to underwater cements designed for curing in seawater. Moreover, in the fabrication of extruded concrete-based building products, cellulose ethers provide green strength to the fabricated concrete pieces prior to curing and the cellulose ethers acts as an extrusion aid.

However, the use of cellulose ethers such as hydroxyethyl cellulose in cementitious compositions results in a substantial increase in the time required for the cement to cure. This time is known as “cement retardation”. Typically the higher the concentration of the hydroxyethyl cellulose in the cementitious composition is, the higher is the degree of cement retardation. In most cementitious compositions a significant cement retardation is undesirable because it increases the production time and, accordingly, the production costs of either fabricated cementitious articles or cementitious formulations used in building or oil field. High cement retardation time can also adversely affect the adhesive properties of cement. If a cellulose ether added to a cementitious formulation retards the cement curing too much, some of the water present in the cement can be lost to the substrate, and this deficiency of water in the cement can result in poor adhesive or lower strength cement in the cured product.

Most commercial hydroxyethyl cellulose polymers have an EO MS (ethylene oxide molar substitution) between 1.5 and 4.0. It is known that increasing the EO MS of hydroxyethyl cellulose gives a reduction in the degree of cement retardation, but merely increasing the EO MS of hydroxyethyl cellulose is not an expedient way to reduce cement retardation. Hydroxyethyl cellulose with a high EO MS is more soluble in organic solvents and more hygroscopic, and is therefore more difficult to manufacture and process, such as washing and drying, particularly in the case of lower molecular weight materials with a viscosity of up to 5000 mPa·s, measured as a 2 weight percent aqueous solution at 25° C. using a Brookfield LVT viscometer. Also, an excessive amount of hydroxyethoxyl substituents on high molecular weight cellulose causes a substantial reduction in the solution viscosity of the polymer in water, which impairs the desired Theological performance of the polymer in many cementitious formulations, such as extruded concrete, spray plasters, or tile adhesives.

European Patent 859 011 B 1 discloses a method of making microfibrils from cationic cellulose. Non-substituted cellulose is used as a starting material, which is reacted with a cationic reagent. Unfortunately, the microfibrils which have a degree of cationic substitution of from 0.1 to 0.7 are to a great extent water-insoluble. Only after passing these cationic cellulose ether through a high-pressure homogeniser, a transparent gel is obtained.

Accordingly, it would be highly desirable to provide new cellulose ethers which are useful in cementitious compositions. It would also be highly desirable to provide a new method of reducing the degree of cement retardation of cellulose ether-comprising cementitious compositions. It would be particularly desirable to reduce the degree of cement retardation in cellulose ether-comprising cementitious compositions without compromising the theological properties of the cellulose ethers or without the need to use cellulose ethers which are difficult to produce and process.

One aspect of the present invention is a cementitious composition which comprises i) a cationically-modified or a secondary or tertiary amino-modified cellulose ether or ii) a cellulose ether comprising a hydroxyethoxyl substituent alone or in combination with one or more other substituents bound to oxygen, wherein the ethylene oxide molar substitution MS_{hydroxyethoxyl} is either from 2.2 to 3.2 and the percentage of unsubstituted anhydroglucose units is up to 8.5 percent or the ethylene oxide molar substitution MS_{hydroxyethoxyl} is less than 2.2 and the percentage of unsubstituted anhydroglucose units is up to 12 percent.

Another aspect of the present invention is a cementitious composition which comprises i) a cationically-modified or a secondary or tertiary amino-modified cellulose ether or ii) a cellulose ether comprising a hydroxyethoxyl substituent alone or in combination with one or more other substituents bound to oxygen, wherein the hydroxyethoxyl substituent has been introduced into the cellulose . . . material in two or more stages.

Yet another aspect of the present invention is a cellulose ether which comprises a hydroxyethoxyl substituent alone or in combination with one or more other substituents bound to oxygen, wherein the ethylene oxide molar substitution MS_{hydroxyethoxyl} is either from 2.2 to 3.2 and the percentage of unsubstituted anhydroglucose units is up to 8.5 percent or the ethylene oxide molar substitution MS_{hydroxyethoxyl} is less than 2.2 and the percentage of unsubstituted anhydroglucose units is up to 12 percent and the viscosity of the cellulose ether is from 3,000 to 10,000 mPa·s, measured as a 1 weight percent aqueous solution at 25° C. using a Brookfield LVT viscometer as described in ASTM method D-2364.

Yet another aspect of the present invention is a cellulose ether comprising a hydroxyethoxyl substituent alone or in combination with one or more other substituents bound to oxygen, wherein the ethylene oxide molar substitution MS_{hydroxyethoxyl} is either from 2.2 to 3.2 and the percentage of unsubstituted anhydroglucose units is up to 8.5 percent or the ethylene oxide molar substitution MS_{hydroxyethoxyl} is less than 2.2 and the percentage of unsubstituted anhydroglucose units is up to 12 percent and the viscosity of the cellulose ether is from 1 to 5000 mPa·s, measured as a 2 weight percent aqueous solution at 25° C. using a Brookfield LVT viscometer as described in ASTM method D-2364.

Yet another aspect of the present invention is a method of controlling the curing time of a cellulose ether-comprising cementitious composition wherein
i) a cationically-modified or a secondary or tertiary amino-modified cellulose ether or
ii) a cellulose ether comprising a hydroxyethoxyl substituent alone or in combination with one or more other substituents bound to oxygen, wherein the ethylene oxide molar substitution MS_{hydroxyethoxyl} is either from 2.2 to 3.2 and the percentage of unsubstituted anhydroglucose units is up to 8.5 percent or the ethylene oxide molar substitution MS_{hydroxyethoxyl} is less than 2.2 and the percentage of unsubstituted anhydroglucose units is up to 12 percent, is incorporated into the cementitious composition.

Yet another aspect of the present invention is a method of controlling the curing time of a cellulose ether-comprising cementitious composition wherein
i) a cationically-modified or a secondary or tertiary amino-modified cellulose ether or
ii) a cellulose ether comprising a hydroxyethoxyl substituent alone or in combination with one or more other substituents bound to oxygen, wherein the hydroxyethoxyl substituent has been introduced into the cellulose material in two or more stages, is incorporated into the cementitious composition.

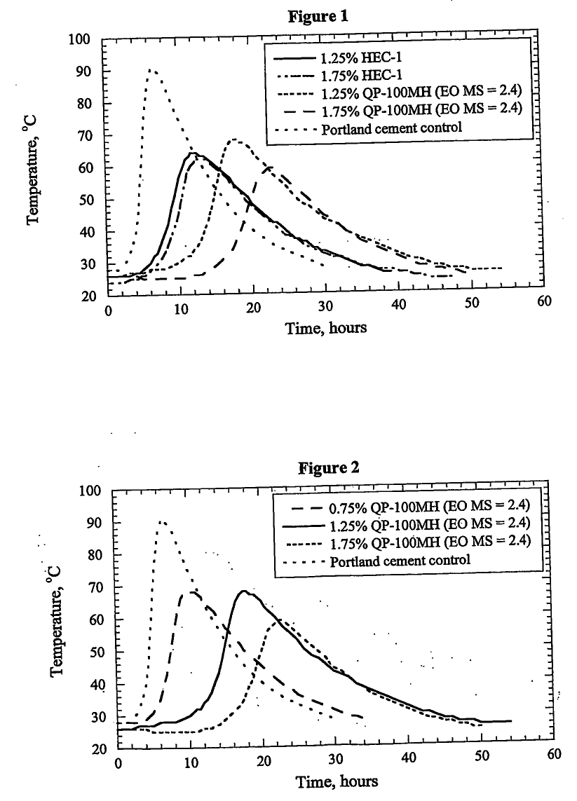

FIG. 1 illustrates the curing time of cementitious compositions of the present invention comprising 1.25 and 1.75 weight percent of a hydroxyethyl cellulose HEC-1 in comparison with the curing time of Portland cement comprising 0 percent of HEC-1, designated as “Portland cement control”, and in comparison with comparative cementitious compositions comprising 1.25 and 1.75 weight percent of a comparative hydroxyethyl cellulose of Comparative Example A, designated as QP-100MH of US origin

FIG. 2 illustrates the curing time of comparative cementitious compositions comprising 0, 0.75, 1.25 and 1.75 weight percent of a comparative hydroxyethyl cellulose of Comparative Example A, designated as QP-100MH of US origin.

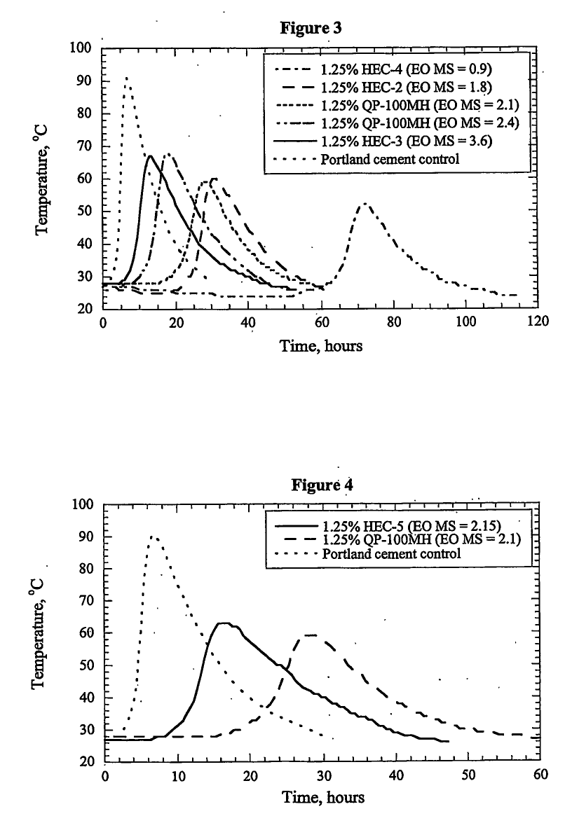

FIG. 3 illustrates the effect of ethylene oxide molar substitution (EO MS) of hydroxyethyl cellulose prepared by a single-step ethoxylation on the curing time of Portland cement.

FIG. 4 illustrates the curing time of cementitious compositions of the present invention comprising 0.1.25 weight percent of a hydroxyethyl cellulose HEC-5 in comparison with the curing time of Portland cement comprising 0 percent of HEC-5 and in comparison with a comparative cementitious composition comprising 1.25 weight percent of a comparative hydroxyethyl cellulose of Comparative Example B, designated as QP-100MH of Belgium origin.

FIG. 5 illustrates the curing time of cementitious compositions of the present invention comprising 1.25 weight percent of tertiary amino-modified hydroxyethyl cellulose polymers, designated as DEAE-HEC and Pip-HEC, in comparison with the curing time of Portland cement comprising 0 percent of a tertiary amino-modified hydroxyethyl cellulose and in comparison with a comparative cementitious composition comprising 1.25 weight percent of a comparative hydroxyethyl cellulose of Comparative Example C, designated as HEC-2.

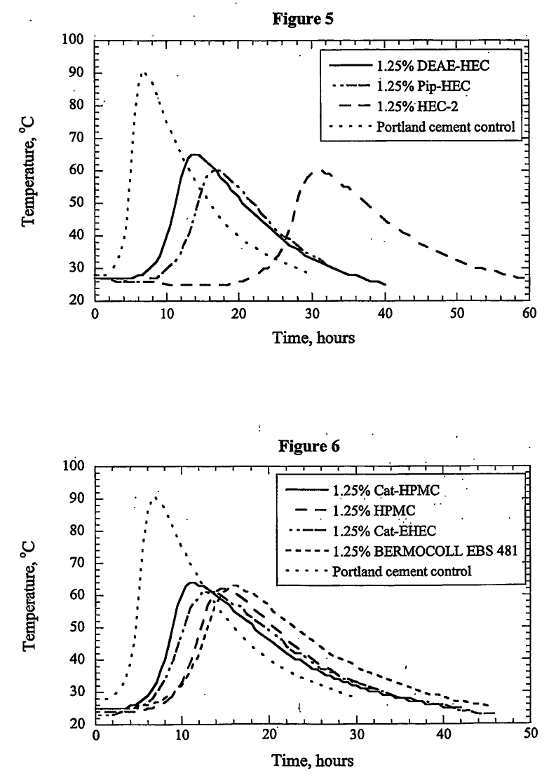

FIG. 6 illustrates the curing time of cementitious compositions of the present invention comprising 1.25 weight percent of cationically-modified alkyl hydroxyalkyl cellulose polymers, designated as Cat-EHEC and Cat-HPMC) in comparison with the curing rate of Portland cement comprising 0 percent of a cationically-modified alkyl hydroxyalkyl cellulose and in comparison with comparative non-modified alkyl hydroxyalkyl cellulose polymers, designated as BERMOCOLL™ EBS-481 EHEC and HPMC (hydroxypropyl methyl cellulose).

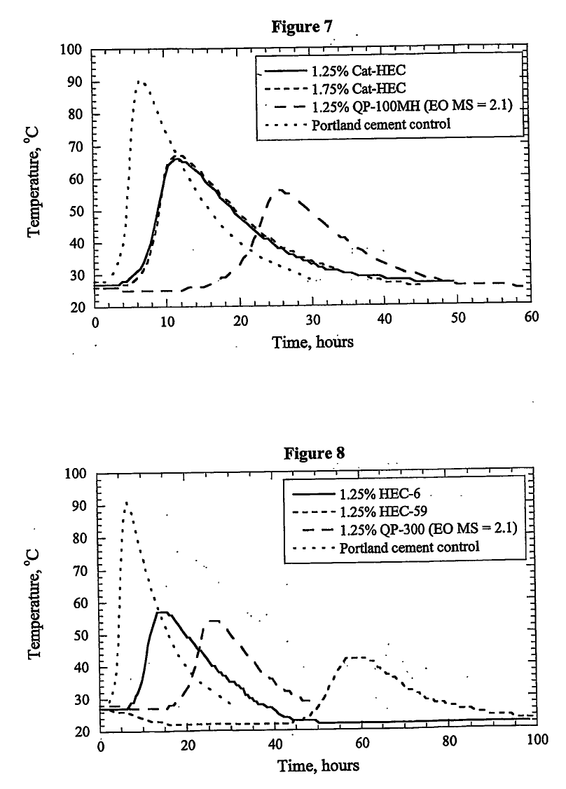

FIG. 7 illustrates the curing time of cementitious compositions of the present invention comprising 1.25 and 1.75 weight percent of a cationically-modified hydroxyethyl cellulose (Cat-HEC) in comparison with the curing time of Portland cement comprising 0 percent of Cat-HEC and with a comparative-cementitious composition comprising 1.25 weight percent of a comparative non-modified hydroxyethyl cellulose of Comparative Example B, designated as QP-100 MH of Belgium origin.

FIG. 8 illustrates the curing time of a cementitious composition of the present invention comprising 1.25 weight percent of a low molecular weight hydroxyethyl cellulose HEC-6 in comparison with two comparative cementitious compositions comprising 1.25 weight percent of a comparative hydroxyethyl cellulose of Comparative Example E, designated as CELLOSIZE™ HEC QP-300 and 1.25 weight percent of a comparative hydroxyethyl cellulose of Comparative Example L, designated as CELLOSIZE™ HEC-59.

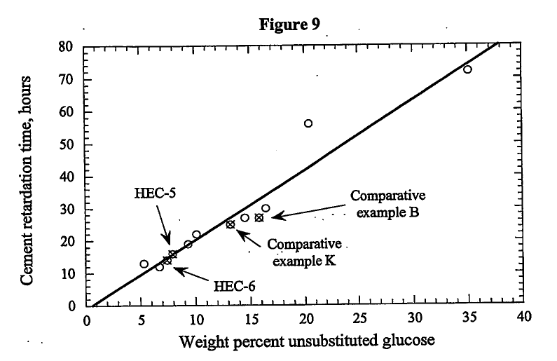

FIG. 9 illustrates the relationship between the degree of cement retardation at 1.25 weight percent hydroxyethyl cellulose as a function of the percent of unsubstituted anhydroglucose repeat units in the hydroxyethyl cellulose.

The cellulose ether of the present invention comprises a hydroxyethoxyl substituent alone or in combination with one or more other substituents bound to oxygen, wherein the ethylene oxide molar substitution MS_{hydroxyethoxyl} is either from 2.2 to 3.2, preferably from 2.2 to 2.6, and the percentage of unsubstituted anhydroglucose units is up to 8.5 percent or the ethylene oxide molar substitution MS_{hydroxyethoxyl} is less than 2.2, preferably from 1.0 to 2.0, and the percentage of unsubstituted anhydroglucose units is up to 12 percent, preferably up to 11.5.

Most preferably, the MS_{hydroxyethoxyl} is up to 3.2, preferably from 0.5 to 3.0, most preferably from 1.5 to 2.8, and the percentage of unsubstituted anhydroglucose units is up to 8.5 percent, preferably up to 8.0 percent, more preferably from 3.0 to 8.0.

The cellulose ether of the present invention has a viscosity which renders it particularly useful . . . in cementitious compositions for specific end-uses. In one aspect of the present invention the cellulose ether has a viscosity of from 3,000 to 10,000, preferably from 3,000 to 7,500 mPa·s, measured as a 1 weight percent aqueous solution at 25° C. using a Brookfield LVT viscometer as described in ASTM method D-2364. The cellulose ether of the present invention with such viscosity is particularly well suited in cementitious compositions which are used for extruded concrete, such as extruded concrete panels; spray plasters, tile adhesives, tape-joint compounds, thin-set mortars, structural pumped concrete, underwater curing concrete, casting, extruding, or grout applications. These high-viscosity cellulose ethers reduce the degree of cement retardation while providing high viscosity to the cementitious compositions at relatively low concentrations of the cellulose ether.

In another aspect of the present invention the cellulose ether has a viscosity of from 1 to 5000, preferably from 1 to 2000, more preferably from 1 to 1000, most preferably from 1 to 700 mPa·s, measured as a 2 weight percent aqueous solution at 25° C. using a Brookfield LVT viscometer as described in ASTM method D-2364. The stated viscosities correspond to a viscosity of from 1 to 500, preferably from 1 to 200, more preferably from 1 to, 100, most preferably from 1 to 70 mPa·s, measured as a 1 weight percent aqueous solution at 25° C. using a Brookfield LVT viscometer as described in ASTM method D-2364. The cellulose ether of the present invention with such viscosity is particularly well suited in cementitious compositions which are used in the oil field industry, for example for oil well cementing. These low-viscosity cellulose ethers reduce the degree of cement retardation and have excellent water retention properties while still having a sufficiently low viscosity that the cement-based slurry can easily pumped into the ground. The cellulose ether significantly reduces water loss of the cementitious compositions into the soil or rock strata, which is critical in oil well cementing for achieving a good strength of the cured cement.

The cellulose ether of the present invention preferably is a hydroxyethyl cellulose, a C₁-C₄-alkyl hydroxyethyl cellulose, such as hydroxyethyl methyl cellulose, ethyl hydroxyethyl cellulose, hydroxyethyl propyl cellulose, or butyl hydroxyethyl cellulose; a hydroxy-C₃₋₄-alkyl hydroxyethyl cellulose, such as hydroxyethyl hydroxypropyl cellulose or hydroxybutyl hydroxyethyl cellulose; or a carboxy-C₁-C₄-alkyl hydroxyethyl cellulose, such as carboxymethyl hydroxyethyl cellulose, carboxybutyl hydroxyethyl cellulose, carboxypropyl hydroxyethyl cellulose or carboxybutyl hydroxyethyl cellulose, wherein the ethylene oxide molar substitution MS_{hydroxyethoxyl} and the percentage of unsubstituted anhydroglucose units are as stated above.

C₁-C₄-alkyl hydroxyethyl celluloses preferably have an alkyl molar substitution DS_{alkoxyl} of from 0.5 to 2.5, more preferably from 1 to 2.5. Hydroxy-C₃₋₄alkyl hydroxyethyl celluloses preferably have a propylene oxide or butylene oxide molar substitution MS_{hydroxy-C3-4-alkoxyl} of from 0.2 to 5.0, preferably from 0.5 to 3.5, more preferably of from 1.0 to 2.0. Carboxy-C₁-C₄-alkyl hydroxyethyl celluloses preferably have a carboxyalkyl molar substitution DS_{carboxyalkoxyl} of from 0.1 to 1.5, preferably from 0.2 to 0.9.

Hydroxyethyl celluloses wherein the ethylene oxide molar substitution MS_{hydroxyethoxyl} and the percentage of unsubstituted anhydroglucose units are as defined above are the most preferred cellulose ethers of the present invention. It has been found that hydroxyethyl cellulose polymers of the present invention with an MS_{hydroxyethoxyl} (EO MS value) of up to 3.2 generally retain the low degree of cement retardation found in hydroxyethyl cellulose polymers with EO MS values of 3.5 or more. In addition, the hydroxyethyl cellulose polymers of the present invention are more easy to manufacture, process, and dry than hydroxyethyl cellulose polymers with EO MS values of 3.5 or more.

It has been found that the hydroxyethoxyl substituents can be introduced into the cellulose material in such a way as to yield a substantially homogeneous distribution of the hydroxyethoxyl residues in the cellulose ether. One way this homogeneous distribution can be achieved is by ethoxylating cellulose in two or more stages. This process preferably comprises the steps of a) alkalizing cellulose and b) contacting the alkali cellulose with ethylene oxide in two or more portions with a reduction in the alkali concentration in each subsequent ethoxylation step.

It has been found that cellulose ethers which comprise a hydroxyethoxyl substituent alone or in combination with one or more other substituents bound to oxygen, wherein the hydroxyethoxyl substituent has been introduced into the cellulose material in two or more stages, are highly useful in cementitious compositions. The preferred ethylene oxide molar substitution MS_{hydroxyethoxyl}, the preferred percentage of unsubstituted anhydroglucose units, the preferred viscosities and the preferred other substituents are those indicated above.

Reaction step a) can be carried out in a known manner. Generally finely divided, preferably ground, cellulose is mixed with water and an alkali metal hydroxide, preferably sodium hydroxide. The cellulose employed is either of natural origin, for example cotton linters or wood pulp, or it is in a regenerated form, such as cellulose hydrate. Prior to the addition of the alkali metal hydroxide, the cellulose can be slurried in a liquid suspending agent as a diluent, such as water or an organic solvent, preferably a straight-chain or cyclic ether, such as dimethyl ether, ethylene glycol monoalkyl ether, ethylene glycol dialkyl ether, dioxane or tetrahydrofuran; a C₁-C₆ alkanol, such as ethanol, 2-propanol (isopropyl alcohol), or 2-methyl-2-propanol (t-butyl alcohol); a ketone, such as acetone or 2-butanone; a C₁-C₄-alkoxy-(C₁-C₆)-alkanol, or an aromatic or aliphatic hydrocarbon, such as toluene, xylene, hexane, cyclohexane, or heptane, or mixtures thereof. Preferably, the weight ratio between the liquid suspending agent and the cellulose is from 0.5, to 50:1, more preferably from 5 to 20:1. Preferably an aqueous solution comprising 15 to 70 percent, more preferably from 20 to 60 percent alkali metal hydroxide, based on the total weight of the aqueous solution, is used. Generally from 0.8 to 3.0 moles, preferably from 1.0 to 2.0 moles of alkali metal hydroxide per mole of anhydro-D-glucose units in the cellulose are used in the alkalizing step a). Alkali metal hydroxides that can be used include lithium hydroxide, sodium hydroxide, and potassium hydroxide, with the preferred alkali metal hydroxide being sodium hydroxide. The reaction between the cellulose and the alkali metal hydroxide is generally carried out at a temperature of from 10 to 50° C., preferably from 15 to 40° C., and at a pressure of from 10 to 1,000 kPa, preferably from 100 to 800 kPa.

Step b) of the process is divided in at least two steps b1) and b2) and optionally one or more additional steps.

In step b1) the alkali cellulose is contacted with a first amount of ethylene oxide to produce hydroxyethyl cellulose which generally comprises from 10 to 60 percent, preferably from 15 to 55 percent, more preferably from 20 to 40 percent of the total hydroxyethoxyl substitution level in the end product originating from the ethoxylation.

In step b2) the concentration of alkali metal hydroxide is generally reduced to 0.01 to 0.8 moles, preferably to 0.2 to 0.4 moles of alkali metal hydroxide per mole of anhydro-D-glucose units in the cellulose by the addition of a suitable mineral acid. Glacial acetic acid is preferred for this purpose. It has been found that the reduction in the alkali metal hydroxide concentration facilitates a more homogeneous distribution of the hydroxyethoxyl substituents in the final product. The partially hydroxyethoxylated alkali cellulose is contacted with a second amount of ethylene oxide. In step b2) generally from 40 to 90 percent, more preferably from 45 to 85 percent, most preferably from 60 to 80 percent of the total hydroxyethoxyl substitution level is introduced into the cellulose ether by ethoxylation. These percentages are not meant to include the hydroxyethoxyl substitution level achieved in step a).

It after step b2) the hydroxyethyl cellulose does not contain 100 percent of the desired total hydroxyethoxyl substitution level, the hydroxethyl cellulose is contacted with a further amount of ethylene oxide in one or more additional steps.

Further portions of other etherifying agents such as ethyl chloride, methyl chloride, propylene oxide, butylene oxide, or n-butyl glycidyl ether may be added if desired. After the ethoxylation is complete and prior to the addition of these other etherifying agents, the caustic level may be increased if desired to facilitate the in situ alkylation of the hydroxyethyl cellulose with these other etherifying agents.

The preferred reaction temperature for carrying out the etherification step b) depends on the particular etherifying agent employed, but typically a temperature of from 25 to 120° C.; preferably from 40 to 110° C. is suitable. Typical reactions conditions for the individual etherifying agents are known to the skilled artisan. Reaction step i) can be cared out in a liquid suspending agent, for example in one listed further above for step a).

Without being bound to a specific theory, it is believed that by the above-described ethoxylation of cellulose in two or more stages, a substantially homogeneous distribution of the hydroxyethoxyl substituents in the hydroxyethyl cellulose is achieved. To measure the homogeneity of distribution of hydroxyethoxyl substituents, hydroxyethyl cellulose polymers prepared by the above-described process of two or more stages are subjected to hydrolysis in dilute aqueous sulfuric acid, and the percent of unsubstituted glucose molecules in the original polymer is measured using the Trinder enzymatic assay method. The principle of this test method, which is specific for glucose, is described by P. Trinder, Ann. Clin. Biochem., 6, 24 (1969). A test kit to conduct the Trinder glucose assay is commercially available from Sigma Diagnostics, P.O. Box 14508, St. Louis, Mo. The percent of unsubstituted glucose residues, that means unsubstituted anhydroglucose units, in the cellulosic backbone of a hydroxyethyl cellulose is used as a measure of the homogeneity of distribution of hydroxyethoxyl substituents in the polymer. A decreasing percentage of unsubstituted glucose is indicative of increasing homogeneity of hydroxyethoxyl substitution on the cellulosic backbone.

The cementitious compositions of the present invention are not limited to those which comprise a cellulose ether wherein a hydroxyethoxyl substituent has been introduced into the cellulose material in two or more stages or which comprise the above-mentioned novel cellulose ethers. Alternatively, the cementitious compositions of the present invention comprises i) a cationically-modified or a secondary or tertiary amino-modified cellulose ether or ii) a cellulose ether comprising a hydroxyethoxyl substituent alone or in combination with one or more other substituents bound to oxygen, wherein the ethylene oxide molar substitution MS_{hydroxyethoxyl} is from 2.2 to 3.2 and the percentage of unsubstituted anhydroglucose units is up to 8.5 percent or the ethylene oxide molar substitution MS_{hydroxyethoxyl} is less than 2.2 and the percentage of unsubstituted anhydroglucose units is up to 12 percent. The preferred ethylene oxide molar unsubstituted MS_{hydroxyethoxyl} and the preferred percentage of unsubstituted anhydroglucose units are those indicated further above.

The viscosity of the cellulose ether in the cementitious compositions of the present invention is generally up to 20,000 mPa·s, preferably from 100 to 20,000 mPa·s, measured as a 1 weight percent aqueous solution at 25° C. using a Brookfield LVT viscometer as described in ASTM method D-2364. The most preferred viscosity depends on the specific end-use of the cementitious composition.

Cementitious compositions which are particularly useful for extruded concrete, such as extruded concrete panels; spray plasters, tile adhesives, tape-joint compounds, thin-set mortars, structural pumped concrete, underwater curing concrete, casting, extruding, or grout applications preferably comprise a cellulose ether which, has a viscosity of from 1,000 to 10,000, preferably from 3,000 to 10,000, most preferably from 3,000 to 7,500 mPa·s, measured as a 1 weight percent aqueous solution at 25° C. using a Brookfield LVT viscometer as described in ASTM method D-2364.

Cementitious compositions which are particularly useful for the oilfield industry, for example for oil well cementing, generally have a viscosity of from 1 to 5000, preferably from 1 to 2000, more preferably from 1 to 1000, most preferably from 1 to 700 mPa·s, measured as a 2 weight percent aqueous solution at 25° C. using a Brookfield LVT viscometer as described in ASTM method D-2364.

The cationically-modified or amino-modified cellulose ether i) comprises an cationic substituent or a secondary amino or tertiary amino substituent in addition to an ether substituent on the cellulosic backbone. Preferred cellulose ethers are C₁-C₄-alkyl celluloses, such as methyl celluloses; C₁-C₄-alkyl hydroxy-C₂-4-alkyl celluloses, such as hydroxyethyl methyl celluloses, hydroxypropyl methyl celluloses or ethyl hydroxyethyl celluloses; hydroxy-C₂-4-alkyl celluloses, such as hydroxyethyl celluloses or hydroxypropyl celluloses; mixed hydroxy-C₂-C₄-alkyl celluloses, such as hydroxyethyl hydroxypropyl celluloses, carboxy-C₁-C₄-alkyl celluloses, such as carboxymethyl celluloses; or carboxy-C₁-C₄-alkyl hydroxy-C₂-C₄-alkyl celluloses, such as carboxymethyl hydroxyethyl celluloses. The preferred backbone or starting material for the cationically-modified or amino-modified cellulose ether is methyl cellulose, hydroxypropyl methyl cellulose, ethyl hydroxyethyl cellulose or hydroxyethyl methyl cellulose, or more preferably, hydroxyethyl cellulose.

More preferably, the cellulose ether which is used for preparing the cationic or amino-modified cellulose ether is a water-soluble cellulose ether, such as a methyl cellulose with a methyl molar substitution DS_{methoxyl} of from 0.5 to 2.5, preferably from 1 to 2; or a hydroxypropyl methyl cellulose with a DS_{methoxyl} of from 0.5 to 2.5, preferably from 1 to 2.5 and a MS_{hydroxyethoxyl} of from 0.05 to 2.0, preferably from 0.1 to 1.5; or a ethyl hydroxyethyl cellulose with a DS_{ethoxyl} of from 0.5 to 2.5, preferably from 1 to 2 and a MS_{hydroxyethoxyl} of from 0.5 to 5.0, preferably from 1.5 to 3.5, more preferably of from 2.0 to 2.5, or a hydroxyethyl methyl cellulose with a DS_{methoxy}, of from 0.5 to 2.5, preferably from 1 to 2 and an MS_{hydroxyethoxyl} of from 0.5 to 5.0, preferably from 1.5 to 3.5, more preferably of from 2.0 to 2.5. Most preferably, a hydroxyethyl cellulose with an EO MS (MS_{hydroxyethoxyl}) of from 0.5 to 5.0, preferably from 1.5 to 3.5, more preferably of from 2.0 to 2.5 is used for preparing the cationically- or amino-modified cellulose ether.

A cationically-modified cellulose ether comprises a cationic substituent which preferably contains nitrogen. The cationic substituent preferably is ammonium group substituted with an alkyl, aryl, alkyl-aryl a heterocyclic ring or a hydroxyalkyl. Preferred cationic substituents have the formula
R₁R₂R₃N⁺R₄—[X⁻] (I),
wherein R₂ and R₃ each independently is alkyl, aryl comprising 5 to 12 carbon atoms; a heterocyclic ring comprising 4 to 11 carbon atoms, or arylalkyl comprising 8 to 18 carbon atoms,
or R₁ or R₂ form together a heterocyclic ring comprising 4 to 11 carbon atoms or an aryl ring comprising 5 to 12 carbon atoms,
R₃ is alkyl, aryl comprising 5 to 12 carbon atoms, a heterocyclic ring comprising 4 to 11 carbon atoms, or arylalkyl comprising 8 to 18 carbon atoms,
R₄ is CH₂CHOHCH₂ or CH₂CH₂; and
X is a halide ion, such as chloride or bromide.

Most preferably, in formula I R₁, R₂, and R₃ are methyl, R is CH₂CHOHCH₂ and X is chloride.

An amino-modified cellulose ether comprises a secondary or tertiary amino group as a substituent Preferred amino substituents have the formula
R₁R₂NR— (II)
wherein R₁ is hydrogen, alkyl, aryl comprising 5 to 12 carbon atoms or a heterocyclic ring comprising 4 to 11 carbon atoms, or arylalkyl comprising 8 to 18 carbon atoms,
R₂ is alkyl, aryl comprising 5 to 12 carbon atoms or a heterocyclic ring comprising 4 to 11 carbon atoms or arylalkyl comprising 8 to 18 carbon atoms,
or R₁ or R₂ form together a heterocyclic ring comprising 4 to 11 carbon atoms or an aryl ring of 5 to 12 carbon atoms, and
R₄ is CH₂CHOHCH₂ or CH₂CH₂.

An alkyl group in formula I or II above preferably contains 1 to 6 carbon atoms, more preferably it is methyl, ethyl, propyl or isopropyl. An aryl group or a heterocyclic ring in formula f or II above preferably comprises 5 or 6 carbon atoms. The heteroatom in a heterocyclic ring in formula I or II above preferably is oxygen or sulfur, more preferably nitrogen.

The substitution level of the cationic substituent or amino substituent on the cellulose ether can be measured as percent nitrogen. Preferably, the substitution is from 0.5 to 5.0 weight percent, more preferably from 1.0 to 3.5 weight percent, most preferably from 1.5 to 2.5 Weight percent of cationic or amino substituent covalently bound to the anhydroglucose repeat units of the cellulose ether, measured as percent nitrogen and based on the total weight of the cellulose ether. The substitution level can be determined by a number of different methods known in the art, for example by nuclear magnetic resonance spectroscopy (NMR). A preferred method for determining percent nitrogen in cellulose ethers is the Kjeldahl method as disclosed in Organic Analysis, volume III, pages 136-141, Interscience Publishers, New York.

The cationically-modified or amino-modified cellulose ether can be produced from the corresponding cellulose ether according to well-known processes, for example as described in U.S. Pat. Nos. 3,472,840; 4,220,548; 4,663,159; 5,407,919 or 5,614,616 or in the published WO 01/48021 A1. A particularly preferred cationizing agent for providing a cationically-modified cellulose ether is (2,3-epoxypropyl)trimethyl ammonium chloride, which is commercially available as a 70 wt percent solids solution from Degussa Corporation as QUAB™ 151. An example of a cationically-modified cellulose ether which is preferably used in the cementitious compositions of the present invention is commercially available from Amerchol Corporation under the trademark UCARE™ Polymer, particularly UCARE™ Polymer JR-30M which is a cationically-modified hydroxyethyl cellulose with a 1 percent Brookfield viscosity of 1000 to 2500 mPa·s and which contains 1.9 weight percent cationic nitrogen as measured by the above-mentioned Kjeldahl method.

The cementitious composition of the present invention generally comprises from 0.05 to 10 weight percent, preferably from 0.1 to 5.0 weight percent, more preferably from 0.5 to 2.0 weight percent of the cellulose ether, based on the total weight of the cementitious composition prior to adding water to the mixture.

The major portion of the cementitious composition of the present invention is generally composed of known components, such as cement, a filler, water and one or more optional additives. The cementitious composition generally comprises from 5 to 80 percent, preferably from 20 to 60 percent of cement, such as Portland cement or alumina cement, based on the total weight of the cementitious composition. Known fillers are for example mineral oxides, hydroxides, clays, metal oxides or hydroxides, quartz and, quartz rock or silica material, such as ground silica sand. The cementitious composition generally comprises from 0 to 80 percent, preferably from 20 to 60 percent of a filler, based on the total weight of the cementitious composition. The amount of water generally is from 10 to 60 percent, preferably from 15 to 40 percent, based on the total weight of the cementitious composition. Examples of cementitious compositions are cement pastes, meaning mixtures comprising cement and water, mortar, meaning mixtures comprising cement, sand, and water; or concrete, meaning mixtures comprising cement, sand, gravel, and water.

Depending on the desired end-use of the cementitious composition, it may comprise a variety of optional additives, such as one or more lightweight additives, fiber reinforcements, floating agents, plasticizers, dispersants, surfactants, retarders, accelerators, fluid loss additives, pigments, wetting agents and/or hydrophobing agents, in known amounts. Lightweight additives can be used as density modifiers, such as fly ash, hollow fly ash, hollow ceramic spheres, expanded polystyrene beads, hollow poly(meth)acrylate beads, vermiculite, perlite or predigested calcium silicate hydrate. Further details are disclosed in WO 00/61519. Useful fiber reinforcements are for example cellulose fibers, such as softwood or hardwood cellulose fibers, non wood cellulose fibers, mineral wool, glass fibers, steel fibers, synthetic polymer fibers or wollastonite fibers. Typical amounts of fiber reinforcements are 3 to 15 percent, based on the total weight of the cementitious composition. Fiber reinforced cementitious compositions are described in U.S. Pat. Nos. 5,047,086 and 6;030,447.

Preferred uses of the cementitious composition of the present invention are described further above.

A cementitious composition of the present invention comprising a cellulose ether i) or ii) above exhibits substantially less cement retardation than a comparable cementitious composition which comprises the same type and amount of a corresponding cellulose ether which has a comparable viscosity and ether substitution level but which is not modified with a cationic or amino substituent, or which comprises a comparable hydroxyethyl cellulose wherein the hydroxyethoxyl substituents are not as homogeneously substituted on the polymer backbone. The curing of cement is an exothermic process, and for the purposes of the present invention, the curing time is defined as the time required for a mixture of cement, water, and cellulose ether to reach the exothermic maximum.

Generally, the time required for the cement to cure in the cementitious compositions of the present invention represents a reduction of 25 percent to up to 60 percent of the time required for the cement to cure in the above-mentioned comparable cementitious compositions prepared with the above-mentioned comparable cellulose ethers. Generally the curing time of the cementitious composition of the present invention comprising a cellulose ether i) or ii) above is only up to 15 hours longer, preferably only up to 9 hours longer, more preferably only 3 hours longer than a corresponding comparative cementitious composition which does not comprise a cellulose ether i) or ii). Moreover, it has been found that the concentration of the cellulose ether i) or ii) can be varied within a concentration range of from 0.25 to 2.5 percent, preferably from 0.50 to 1.50 percent, more preferably from 0.75 to 1.25 percent without decreasing or increasing the time to cure the cement by more than +10 percent.

The invention is illustrated by the following examples which should not be construed to limit the scope of the present invention. Unless stated otherwise all parts and percentages are given by weight.

For each cellulose ether polymer, the volatiles content is measured by mass loss on drying at 105° C. for one hour, and the ash content is measured by wet ashing with sulfuric acid as described in ASTM method D-2364. The solution viscosity of each cellulose ether polymer is measured using a Brookfield model LVT viscometer using spindle #3 or #4 at 30 rpm using 1 percent aqueous solutions (corrected for volatiles content of the cellulose ether) as described in ASTM method D-2364, unless otherwise stated. The EO MS (ethylene oxide molar substitution, MS_{hydroxyethoxyl}) of the hydroxyethyl cellulose polymers or polymers prepared from hydroxyethyl cellulose is determined either by simple mass gain or using the Morgan modification of the Zeisel method, P. W. Morgan, Ind. Eng. Chem., Anal. Ed., 18, 500 (1946). The procedure is also described on pages 309-314 of “Methods in Carbohydrate Chemistry”, Volume 3, edited by R. L. Whistler, Academic Press, New York, 1963.

The curing time of the cementitious compositions is determined by measuring the time required to reach the maximum of the exothermic peak during setting using a simple adiabatic calorimeter. An aqueous solution of cellulose ether polymer prepared by rolling the mixture for eight hours at room temperature on a roller mill. For a final concentration of 1:25 percent cellulose ether in cement, 3.94 g of cellulose ether polymer and 196.06 g of water are so mixed. All percentages of cellulose ethers are based on weight percent relative to Portland cement prior to the addition of water. 175.0 g of this aqueous solution of cellulose ether polymer are mixed with 275.0 g of Portland cement (type 1) by hand. Portland cement (type 1) was purchased from Quikrete Incorporated, Atlanta, Ga. (USA) and meets all requirements of ASTM C-150. The top of a 500 ml high density polyethylene narrow-mouth bottle (Nalgene™ catalog #2002-0016) is cut-off to give a cylindrical container 10.3 cm high and 7.2 cm outside diameter. The mixture of cement, water, and cellulose ether polymer is placed in this cylindrical container, and placed inside a Dewar flask (Labglass™ catalog # LG-7590-100, 80 mm inside diameter). The tip of a disposable polyethylene transfer pipet (Fisherbrand™, catalog # 13-711-7) is cut off and filled with high thermal conductivity paste (Omegatherm™ 201 paste, Omega catalog #OT-201). The pipet tip is then inserted over the end of a stainless steel tube (5¾ inch long, ⅛ inch diameter, and 0.035 inch wall), and a thermocouple probe and connector (Omega # JMQSS-032G-6 and # HST-J-F) are threaded through the tube and into the pipet tip. The thermocouple/steel tube/pipet tip assembly is then mounted in a neoprene rubber stopper (Fisherbrand catalog # 14-141V) such that when the rubber stopper is used to close the Dewar flask, the thermocouple would be inserted into the cement mixture approximately half way. The thermocouple is then connected to a temperature module (Fisher Scientific catalog # 13-935-14) using a connector (Omega # HST-J-M) and then a strip chart recorder (two pen modular, Fisher Scientific catalog-# 13-935-11) using an extension wire (Omega # EXPP-J-20): The Dewar flask is closed with the large neoprene rubber stopper that is vented with a syringe needle. A similar calorimeter is also described in ASTM method C-186.

The cement curing rate of a cementitious composition is also measured by the needle setting time which determines the time required to achieve a specific consistency whereby a needle in controlled conditions can no longer penetrate the curing cementitious formulation. The test is performed using a Vicat Needle testing apparatus described in ASTM method C-191. An aqueous solution of cellulose ether is prepared by dissolving 1.086 grams of cellulose ether in 99 grams of demineralized water. A mixture of 99 grams of Portland cement CEM II/B-V 32,5. R PPZ 30, commercially available from Compagnie des Ciments Belges, CCB and 351 grams of Rhine Sand 0/2 is blended in a Turbula (Trademark) mixer during 15 minutes. This cement-sand muter is placed in a rubber cup and mixed with 50 grams of the aqueous solution of the cellulose ether using an anchor-shape stirrer at 50 to 100 rpm until a homogeneous paste is obtained. This paste is subsequently placed in a Vicat ring of 4 cm height, 8 cm upper cone diameter and 9 cm lower cone diameter which must be filled completely without pressing or striking the surface too intensively to prevent separation of the composition. The Vicat ring is placed with the small side upward under the Vicat needle setting apparatus with the needle in the highest position and the measurement is started.

The low viscosity cellulose ethers described in this invention are evaluated for fluid loss using a low pressure filter press as described in the API (American Petroleum Institute) RP 10B method.

The cement slurry used in this test has the following composition: 297.83 g water, 73.2 g sodium chloride, 2.17 g cellulose ether or polyvinyl alcohol and 430.1 g Portland cement CEM II/B-V 32,5 R PPZ 30, commercially available from Compagnie des Ciments Belges, CCB. This mixture is stirred in a Waring blender at high speed for 35 seconds before performing the fluid loss test. The low pressure filter press (Baroid Series 300 API Filter Press) is equipped with a filter medium consisting of a No. 325 mesh standard sieve supported by a No. 60 mesh standard sieve. The test is performed at ambient temperature around 20° C.

### EXAMPLE 1

1a) Preparation of Hydroxyethyl Cellulose (HEC-1)

A three pint, glass Chermco™ pressure reactor is charged with 25.00 g of Buckeye™ HVE cotton linters (corrected for volatiles, laboratory cut), 348.8 g of acetone, 45.0 g of absolute ethanol, and 56.2 g of distilled water. The mixture is stirred for one hour while purging the headspace of the reactor with nitrogen at a rate of 500 ml/min to remove any entrained oxygen. The reactor is fitted with an ice water condenser to prevent evaporative losses of the diluent during the nitrogen purge. After 30 minutes of purging, the slurry is warmed to 32° C. using a water bath.

After purging for one hour and while holding at 32° C., 45.45 g of 22 percent aqueous sodium hydroxide solution are added to the slurry by syringe, and the slurry temperature rises from 32° C. to 35° C. The slurry is stirred for one hour at 35° C., while continuing the nitrogen headspace purge. The molar ratio of sodium hydroxide to cellulose in this first step is 1.62. A first charge of 12.5 g of freshly distilled ethylene oxide is added to the reactor and with continuous s tiring the reactor is sealed. The slurry is heated with a water bath to 75° C. during a heat-up time of 35 minutes. One hour after reaching 75° C., the molar ratio of sodium hydroxide to cellulose of the reaction is adjusted by adding 12.3 g of glacial acetic acid to the reactor, and stirring for 15 minutes. The molar ratio of sodium hydroxide to cellulose for the second step of the reaction is 0.29. A second charge of 20.0 g of ethylene oxide is added to the reactor. The reaction is heated to 80° C. and held at 80° C. for 4 hours and 20 minutes.

The slurry is cooled to room temperature and 5.00 g of glacial acetic acid are added by syringe. After stirring for 15 minutes, the polymer is collected by vacuum filtration through a fritted metal Buchner funnel. The polymer is washed in a Waring blender four times with 500 g of acetone/water at a volume ratio of 4:1 and twice with 500 ml of undiluted acetone. The polymer is dried in vacuo at 50° C. overnight, yielding 46.35 g of an off-white solid.

The volatiles content is 1.5 percent, the ash content (calculated as sodium acetate) is 6.2 percent, and the calculated mass gain EO MS (MS_{hydroxyethoxyl}) is 2.6. The viscosity of a 1 weight percent aqueous solution of the hydroxyethyl cellulose, corrected for volatiles, is 3300 mPa·s.

1b) Preparation of a Cementitious Composition

An aqueous solution of 3.94 g of the produced HEC-1 in 196.06 g of distilled water is prepared by rolling for eight hours at room temperature on a roller mill. 175.0 g of this 1.97 percent aqueous solution of HEC-1 is mixed with 275.0 g of Portland cement (type 1) by hand, then transferred to a polyethylene container and placed in a Dewar flask. The produced cementitious composition comprises 1.25 percent of HEC-1, based on dry cement. Its temperature is monitored using a thermocouple, and the temperature data as a function of time is recorded on a strip chart recorder. The curing time of the cement mixture is 12 hours.

A cementitious composition comprising 1.75 percent of HEC-1, based on dry cement, is prepared in the same manner. The curing time of the cement mixture is also 12 hours.

### COMPARATIVE EXAMPLE A

A cement mixture as in Example 1b is prepared, except that a hydroxyethyl cellulose is used which is commercially available as CELLOSIZE™ HEC QP-100 MH, made in ‘the ’ US by Union Carbide Corporation, as subsidiary of The Dow Chemical Company. This hydroxyethyl cellulose has an EO MS (MS_{hydroxyethoxyl}) of 2.4 and was manufactured in an aqueous acetone/ethanol diluent. The hydroxyethyl groups have been introduced into the cellulose in a single stage. The viscosity of a 1 weight percent aqueous solution of this hydroxyethyl cellulose, corrected for volatiles, is 4830 mPa·s. The curing time of the cement mixture comprising 1.25 percent of hydroxyethyl cellulose, based on dry cement, is 19 hours.

Two additional cement mixtures, one comprising 0.75 percent, the other comprising 1.75 percent of CELLOSIZE™ HEC QP-100 MH cellulose ether, are prepared. The curing time of the three mixtures (10, 19, and 23 hours, respectively) is compared with the curing time of Portland cement comprising 0 percent of the hydroxyethyl cellulose (7 hours).

### COMPARATIVE EXAMPLE B

A cement mixture as in Example 1b is prepared, except that a hydroxyethyl cellulose is used which is commercial available as CELLOSIZE™ HEC QP-100 MH, made in Belgium by Union Carbide Benelux, as subsidiary of The Dow Chemical Company. This hydroxyethyl cellulose has an EO MS (MS_{hydroxyethoxyl}) of 2.1 and was manufactured in an aqueous isopropyl alcohol diluent. The hydroxyethyl groups have been introduced into the cellulose in a single stage. The viscosity of a 1 weight percent aqueous solution of this hydroxyethyl cellulose, corrected for volatiles, is 5130 mPa·s. The curing time of the cement mixture comprising 1.25 percent of hydroxyethyl cellulose, based on dry cement, is 27 hours.

### COMPARATIVE EXAMPLE C

C.a. Preparation of Hydroxyethyl Cellulose (HEC-2)

A three pint, glass Chemco™ pressure reactor is charged with 25.00 g of Southern™ 407 cotton linters (corrected for volatiles, laboratory cut), 317.9 g of acetone, 44.6 g of absolute ethanol, and 42.5 g of distilled water. The mixture is stirred for one hour while purging the headspace of the reactor with nitrogen at a rate of 500 ml/min to remove any entrained oxygen. The reactor is fitted with an ice water condenser to prevent evaporative losses of the diluent during the nitrogen purge After 30 minutes of purging, the slurry is warmed to 32° C. using a water-bath.

After purging for one hour and while holding at 32° C., 43.75 g of 22 percent aqueous sodium hydroxide solution are added to the slurry by syringe, and the slurry temperature raises from 32° C. to 35° C. The slurry is stirred for one hour at 35° C., while continuing the nitrogen headspace purge. The molar ratio of sodium hydroxide to cellulose is 1.56. 23.0 g of freshly distilled ethylene oxide is added to the reactor and with continuous stirring the reactor is sealed. The slurry is heated with a water bath to 75° C. during a heat-up time of 35 minutes, and the mixture is allowed to react for one hour at 75° C.

The slurry is cooled to room temperature and 16.00 g of glacial acetic acid are added by syringe. After stirring for 15 minutes, the polymer is collected by vacuum filtration through a fritted metal Buchner funnel. The polymer is washed in a Waring blender four times with 500 g of acetone/water at a volume ratio of 4:1 and twice with 500 ml of undiluted acetone. The polymer is dried in vacuo at 50° C. overnight, yielding 40.46 g of an off-white solid.

The volatiles content is 1.1 percent, the ash content (calculated as sodium acetate) is 7.2 percent, and the calculated mass gain EO MS (MS_{hydroxyethoxyl}) is 1.8. The viscosity of a 1 weight percent aqueous solution of the hydroxyethyl cellulose, corrected for volatiles, is 3950 mPa·s.

C.b. Preparation of a Cementitious Composition

A cement mixture as in Example 1b is prepared, except that the hydroxyethyl cellulose polymer HEC-2 is used. The hydroxyethyl groups have been introduced into the cellulose in a single stage. This hydroxyethyl cellulose has an EO MS (MS_{hydroxyethoxyl}) of 1.8, and a 1 weight percent aqueous solution viscosity, corrected for volatiles, of 2950 mPa·g. The curing time of the cement mixture comprising 1.25 percent of hydroxyethyl cellulose HEC-2, based on dry cement, is 30 hours.

### COMPARATIVE EXAMPLE D

D.a. Preparation of Hydroxyethyl Cellulose (HEC-3)

The same procedure as in Comparative Example C.a. is used, except that the 22 percent aqueous caustic charge is 43.2 g and the ethylene oxide charge is 45.0 g. After washing, the polymer is dried in vacuo at 50° C. overnight, yielding 55.48 g of an off-white solid. The volatiles content is 4.4 percent, the ash content (calculated as sodium acetate) is 7.0 percent, and the calculated mass gain EO MS (MS_{hydroxyethoxyl}) is 3.6. The viscosity of a 1 weight percent aqueous solution of the hydroxyethyl cellulose, corrected for volatiles, is 2700 mPa·s.

D.b. Preparation of a Cementitious Composition

A cement mixture as in Example 1b is prepared, except that the hydroxyethyl cellulose polymer HEC-3 is used. The hydroxyethyl groups have been introduced into the cellulose in a single stage. This hydroxyethyl cellulose has an EO MS (MS_{hydroxyethoxyl}) of 3.6, and a 1 weight percent aqueous solution viscosity of 2700 mPa·s. The curing time of the cement mixture comprising 1.25 percent of hydroxyethyl cellulose HEC-3, based on dry cement, is 13 hours. The hydroxyethyl cellulose polymer HEC-3 provides a short curing time to the cement mixture. However, HEC-3 has a high EO MS and is difficult to be manufactured and processed, such as washed and dried, due to its hygroscopic nature. Furthermore, it has an undesirably low viscosity for extruded concrete, spray plasters, tile adhesives.

### COMPARATIVE EXAMPLE E

E.a. Preparation of Hydroxyethyl Cellulose (HEC-4)

The same procedure as in Comparative Example C.a. is used, except with the following changes: 25.00 g of Buckeye HVE cotton linters (corrected for volatiles, laboratory cut) are used, the diluent composition is 348.8 g of acetone, 45:0 g of ethanol, and 56.2 g of water, the 22 percent aqueous caustic charge is 45.45 g, and the ethylene oxide charge is 12.5 g. After washing, the polymer is dried in vacuo at 50° C. overnight, yielding 33.61 g of an off-white solid. The volatiles content is 2.9 percent, the ash content (calculated as sodium acetate) is 5.0 percent, and the calculated mass gain EO MS (MS_{hydroxyethoxyl}) is 0.9 The polymer is not completely soluble in water, so the viscosity measurement is not made.

E.b. Preparation of a Cementitious Composition

A cement mixture as in Example 1b is prepared, except that the hydroxyethyl cellulose polymer HEC-4 is used. The hydroxyethyl groups have been introduced into the cellulose in a single stage. This hydroxyethyl cellulose has an EO MS (MS_{hydroxyethoxyl}) of 0.9. The curing time of the cement mixture comprising 1.25 percent of hydroxyethyl cellulose HEC-4, based on dry cement, is 72 hours.

### EXAMPLE 2

2a Preparation of Hydroxyethyl Cellulose (HEC-5)

A three pint, glass Chemco™ pressure reactor is charged with 30.00 g of Buckeye™ HVE cotton linters (corrected for volatiles, laboratory cut), 363.3 g of isopropyl alcohol and 56.7 g of distilled water. The mixture is stirred for one hour while purging the headspace of the reactor with nitrogen at a rate of 500 ml/min to remove any entrained oxygen. The reactor is fitted with an ice water condenser to prevent evaporative losses of the diluent during the nitrogen purge. The temperature of the slurry is maintained below 25° C. using a water bath as necessary.

After purging for one hour and while holding at 25° C., 19.2 g of 50 percent aqueous sodium hydroxide solution are added to the slurry by syringe while holding the slurry temperature to 25° C. The slurry is stirred for one hour while continuing the nitrogen headspace purge. The molar ratio of sodium hydroxide to cellulose in this first step is 1.30. A first charge of 12.8 g of freshly distilled ethylene oxide is added to the reactor and with continuous stirring the reactor is sealed. The slurry is heated with a water bath to 75° C. during a heat-up time of 35 minutes. One hour after reaching 75° C., the molar ratio of sodium hydroxide to cellulose of the reaction is adjusted by adding 11.03 g of glacial acetic acid to the reactor, and stirring for 15 minutes. The molar ratio of sodium hydroxide to cellulose for the second step of the reaction is 0.30. A second charge 6 of 2.0.7 g of ethylene oxide is added to the reactor. The reaction is heated to 80° C. and held at 80° C. for 4 hours and 20 minutes.

The slurry is cooled to room temperature and 5.00 g of glacial acetic acid are added by syringe. After stirring for 15 minutes, the polymer is collected by vacuum filtration through a fritted metal Buchner funnel. The polymer is washed in a Waring blender four times with 500 g of acetone/water at a volume ratio of 4:1 and twice with 500 ml of undiluted acetone. The polymer is dried in vacuo at 50° C. overnight, yielding 50.74 g of an off-white solid.

The volatiles content is 0.9 percent, the ash content (calculated as sodium acetate) is 5.5 percent, and the calculated mass gain EO MS (MS_{hydroxyethoxyl}) is 2.15. The viscosity of a 1 weight percent aqueous solution of the hydroxyethyl cellulose, corrected for volatiles, is 6100 mPa·s.

2b) Preparation of a Cementitious Composition

A cement mixture as in Example 1b is prepared, except that the hydroxyethyl cellulose polymer HEC-5 is used. The hydroxyethyl groups have been introduced into the cellulose using a two-stage process. This hydroxyethyl cellulose has an EO MS (MS_{hydroxyethoxyl}) of 2.15, and a 1 weight percent aqueous solution viscosity of 6100 mPa·s. The curing time of the cement mixture comprising 1.25 percent of hydroxyethyl cellulose HEC-5, based on dry cement, is 16 hours.

FIG. 1 illustrates the curing times of the cementitious compositions of Example 1 comprising 1.25 and 1.75 weight percent respectively of the hydroxyethyl cellulose HEC-1 in comparison with the curing time of Portland cement comprising 0 percent of HEC-1 and in comparison with the cementitious compositions of Comparative Example A comprising 1.25 and 1.75 weight percent respectively of the comparative CELLOSIZE™ HEC QP-100 MH cellulose ether (US origin). FIG. 1 illustrates that the curing times of the cementitious compositions of Example 1 are significantly shorter than those of Comparative Example A although the EO MS values of hydroxyethyl cellulose HEC-1 and CELLOSIZE™ HEC QP-100 MH cellulose ether of Comparative Example A are comparable (2.6 versus 2.4). This finding is unexpected and surprising.

FIG. 2 illustrates the concentration dependence of the comparative CELLOSIZE™ HEC QP-100 MH cellulose ether of Comparative Example A on the curing time of Portland cement. This concentration dependence is absent to a large degree with the hydroxyethyl cellulose polymers present in the cementitious compositions of the present invention. It, is surprising that the curing time of the cementitious compositions of Example 1 is significantly less dependent on the concentration of the hydroxyethyl cellulose than the curing time in Comparative Example A.

It is known that cementitious compositions comprising common hydroxyethyl cellulose cure the faster the higher the MS_{hydroxyethoxyl} of the hydroxyethyl cellulose is. The known rule is confirmed by comparing the curing times of the comparative data for Comparative Examples A, B, C, and D in FIG. 3. The MS_{hydroxyethoxyl} of the hydroxyethyl celluloses in Comparative Examples E, C, B, A, and D are 0.9, 1.8, 2.1, 2.4, and 3.6, respectively, and the curing times of the cementitious compositions comprising them are 72, 30, 27, 19, and 13 hours, respectively.

FIG. 4 illustrates that the curing times of the cementitious compositions of Example 2 are significantly shorter than those of Comparative Example B although the EO MS values of hydroxyethyl cellulose HEC-5 and CELLOSIZE™ HEC QP-100 MH cellulose ether in Comparative Example B are comparable (2.15 versus 2.1). This finding is unexpected and surprising.

### EXAMPLE 3

Preparation of Diethylaminoethyl-Modified Hydroxyethyl Cellulose (DEAE-HEC)

A 500 ml resin kettle is fitted with a stirring paddle and motor, Friedrich condenser and mineral oil bubbler, serum cap, and a subsurface nitrogen feed. The resin kettle is charged with 27.0 g of hydroxyethyl cellulose polymer HEC-2, 170.0 g of acetone, 23.5 g of ethyl alcohol, and 22.5 g of distilled water. The slurry is stirred for 30 minutes at ambient temperature while purging with nitrogen. Then, 9.00 g of 50 percent aqueous sodium hydroxide solution are added dropwise by syringe over five minutes under nitrogen. The slurry is then stirred for 30 minutes under nitrogen.

38.0 g of 2,2-diethylaminoethyl chloride hydrochloride are placed in a 250 ml volumetric flask and diluted to the mark with 10 percent aqueous sodium hydroxide solution. The liberated free base (diethylaminoethyl chloride) rises to the top of the flask. The free base is removed by pipetting, and after weighing is dissolved in a minimum of acetone. The causticized HEC-2 slurry is heated to reflux, and an equivalent of 25.0 g of diethylaminoethyl chloride solution is added to the HEC-2 slurry dropwise over 5 minutes while stirring under nitrogen. The mixture is then allowed to reflux for 3 hours while stirring under nitrogen.

The slurry is cooled to room temperature and neutralized by adding 7.50 g of glacial acetic acid dropwise and stirring for 15 minutes. The polymer is collected by vacuum filtration through a fritted metal Buchner funnel and washed in a Waring blender eight times with 500 ml of acetone/water at a volume ratio of 4:1 and four times with 500 ml of pure acetone. The polymer is dried in vacuo at 50° C. overnight, yielding 31.6 g of an off-white solid with a volatiles content of 1.4 percent, an ash content of 2.5 percent (calculated as sodium acetate), and a Kjeldahl nitrogen content (corrected for ash and volatiles) of 2.92 percent (DEAE MS=0.70). The 1 percent Brookfield viscosity of the polymer is 2600 cP (spindle #3, 6 rpm, corrected for volatiles),

A cement mixture as in Example 1b is prepared, except that the diethylaminoethyl hydroxyethyl cellulose polymer DEAE-HEC is used. The curing time of the cement mixture comprising 1.25 percent of polymer DEAE-HEC, based on dry cement, is 13.5 hours.

### EXAMPLE 4

Preparation of Piperidine-Modified Hydroxyethyl Cellulose (Pip-HEC)

A 500 ml resin kettle is fitted with a stirring paddle and motor, Friedrich condenser and mineral oil bubbler, serum cap, and a subsurface nitrogen feed. The resin kettle is charged with 28.0 g of hydroxyethyl cellulose polymer HEC-2, 188.4 g of acetone, 26.4 g of ethyl alcohol, and 25.2 g of distilled water. The slurry is stirred for 30 minutes at ambient temperature while purging with nitrogen. Then, 9.00 g of 50 percent aqueous sodium hydroxide solution are added dropwise by syringe over five minutes under nitrogen. The slurry is then stirred for 30 minutes under nitrogen.

40.7 g of 0.1-(2-chloroethyl)piperidine hydrochloride are placed in a 250 ml volumetric flask and diluted to the mark with 10 percent aqueous sodium hydroxide solution. The liberated free base rises to the top of the flask. The free base is removed by pipetting, and after weighing is dissolved in a minimum of acetone. The causticized HEC slurry is heated to reflux, and an equivalent of 27.2 g of the 1-(2-chloroethyl)piperidine free base is added to the HEC slurry dropwise over 5 minutes while stirring under nitrogen. The mixture is then allowed to reflux for 4 hours while stirring under nitrogen.

The slurry is cooled to room temperature and neutralized by adding 7.50 g of glacial acetic acid dropwise and stirring for 15 minutes. The polymer is collected by vacuum filtration through a fritted metal Buchner funnel and washed in a Warning blender eight times with 500 ml of acetone/water at a volume ratio of 4:1 and four times with 500 ml of pure acetone. The polymer is dried in vacuo at 50° C. overnight, yielding 35.30 g of an off-white solid with a volatiles content of 4.7 percent, an ash content of 2.2 percent (as sodium acetate), and a Kjeldahl nitrogen content (corrected for ash and volatiles) of 2.69 percent (piperidine MS=0.60). The 1 percent Brookfield viscosity of the polymer is 1380 cP (spindle #3, 30 rpm, corrected for volatiles).

A cement mixture as in Example 1b is prepared, except that the piperidine-modified hydroxyethyl cellulose polymer pip-HEC is used. The curing time of the cement mixture comprising 1.25 percent of polymer pip-HEC, based on dry cement, is 16.5 hours.

FIG. 5 illustrates the effect of tertiary amino-modification of hydroxyethyl cellulose on the degree of Portland cement retardation. The presence of tertiary amino groups diethylaminoethyl or piperidine on the hydroxyethyl cellulose backbone at MS values of 0.70 and 0.60 respectively affords a significant reduction in: the degree of cement retardation compared to the starting hydroxyethyl cellulose HEC-2.

### EXAMPLE 5

Preparation of Cationic Ethyl Hydroxyethyl Cellulose (Cat-EHEC)

A 500 ml resin kettle is fitted with a stirring paddle and motor, a serum cap, a nitrogen inlet, and a Friedrich condenser with a mineral oil bubbler. The resin kettle is charged with 25.0 g of BERMOCOLL™ EBS 481 FQ ethyl hydroxyethyl cellulose (EHEC), 112.5 g of acetone, and 12.5 g of distilled water. The mixture is purged with nitrogen for one hour while stirring. After one hour of stirring under nitrogen; 3.63 g of a 22 percent aqueous sodium hydroxide solution are added by syringe under nitrogen dropwise over 5 minutes, aid stirring is continued for an additional hour.

17.85 g of a 70 percent aqueous solution of QUAB™ 151 ((2,3-epoxypropyl)trimethyl ammonium chloride); commercially available from Degussa Corporation, is added by syringe over 5 minutes to the slurry under nitrogen. Heat is applied to the slurry by a heating mantle, and the mixture is refluxed for 2 hours with stirring under nitrogen. The slurry is then cooled to room temperature and neutralized by adding 2.00 g of glacial acetic acid by syringe and stirring for 15 minutes. The polymer is recovered by vacuum filtration, and washed in a Waring blender once with 500 ml of acetone/water at a volume ratio of 10:1, three times with 500 ml of pure acetone, once with 500 mil of acetone/water at a volume ratio of 7:1, and twice with 500 ml of pure acetone. The polymer is dried in vacuo at 50° C. overnight, yielding an off-white solid with a volatiles content of 1.1 percent, an ash content of 1.6 percent (calculated as sodium acetate), and a Kjeldahl nitrogen content (corrected for ash and volatiles) of 2.04 percent (Cationic Substitution CS=0.57). The 1 percent Brookfield viscosity of the polymer is 2280 cP (spindle #3, 30 rpm, corrected for ash and volatiles).

A cement mixture as in Example 1b is prepared, except that the cationic ethyl hydroxyethyl cellulose polymer Cat-EHEC is used. The curing time of the cement mixture comprising 1.25 percent of polymer Cat-EHEC, based on dry cement, is 12.4 hours.

### EXAMPLE 6

Preparation of Cationic Hydroxyoropyl Methyl Cellulose (Cat-HPMC)

A 500 ml resin kettle is fitted with a stirring paddle and motor, a serum cap, a nitrogen inlet, and a Friedrich condenser with a mineral oil bubbler. The resin kettle is charged with 20.0 g of hydroxypropyl methyl cellulose which is commercially available from Aldrich Chemical Company, has a methoxyl DS of 1.1 to 1.6, a hydroxypropoxyl MS of 0.1 to 0.3, and a 2 percent viscosity of 100,000 cP, 135.0 g of t-butyl alcohol, and 15.0 g of distilled water. The mixture is purged with nitrogen for one hour while stirring. After one hour of stirring under nitrogen, 3.50 g of a 22 percent aqueous sodium hydroxide solution are added by syringe under nitrogen dropwise over 5 minutes, and stirring is continued for an additional hour.

12.0 g of a 70 percent aqueous solution of QUAB™ 151 ((2,3-epoxypropyl)trimethyl ammonium chloride), commercially available from Degussa, is added by syringe over 5 minutes to the slurry under nitrogen. Heat is applied to the slurry by a heating mantle, and the mixture is refluxed for 2 hours with stirring under nitrogen. The slurry is then cooled to room temperature and neutralized by adding 2.00 g of glacial acetic acid by syringe and stirring for 15 minutes. The polymer is recovered by vacuum filtration, and washed in a Waring blender ten times with 250 ml of acetone/water at a volume ratio of 15.7:1, twice with 250 ml of pure acetone, three times with 250 ml of acetone/water at a volume ratio of 8:1, once with 250 ml of acetone/water at a volume ratio of 10:1, and twice with 250 ml of pure acetone. The polymer is dried in vacuo at 50° C. overnight, yielding 18.32 g of an off-white solid. The volatiles content is 1.8 percent, the ash content (calculated as sodium acetate) is 0.63 percent, and the Kjeldahl nitrogen (corrected for ash & volatiles) is 1.56 percent. Assuming a hydroxypropoxyl MS of 0.2 and a methoxyl DS of 1.35 (the average values of the ranges given in the product specification), the Cationic Substitution CS is calculated to be 0.26. The 1 percent Brookfield viscosity of the polymer is 1130 cP (spindle #3, 30 rpm; corrected for ash and volatiles).

A cement mixture as in Example 1b is prepared, except that the cationic hydroxypropyl methyl cellulose polymer Cat-HPMC is used. The curing time of the cement mixture comprising 1.25 percent of polymer Cat-HPMC, based on dry cement, is 11.0 hours.

### COMPARATIVE EXAMPLE F

A cement mixture as in Example 1b is prepared, except that an ethyl hydroxyethyl cellulose is used which is commercially available as BERMOCOLL™ EBS-481 FQ from Akzo-Nobel. This ethyl hydroxyethyl cellulose has an ethoxyl DS of 0.8-0.9 and an EO MS (MS_{hydroxyethoxyl}) of 2.5-2.9. The viscosity of a 1 weight percent aqueous solution of this ethyl hydroxyethyl cellulose is 2720 mPa·s. The curing time of the cement mixture comprising 1.25 percent of hydroxyethyl cellulose, based on dry cement, is 15.5 hours.

### COMPARATIVE EXAMPLE G

A cement mixture as in Example 1b is prepared, except that a hydroxypropyl methyl cellulose (HPMC) is used which is commercially obtainable from Aldrich Chemical Company. This hydroxypropyl methyl cellulose has a methoxyl DS of 1.1 to 1.6, a hydroxypropoxyl MS of 0.1 to 0.3, and a 1 percent Brookfield viscosity in water of 2800 mPa·s (spindle #3, 30 rpm). The curing time of the cement mixture comprising 1.25 percent of hydroxypropyl methyl cellulose, based on dry cement, is 14.5 hours.

FIG. 6 illustrates the curing times of cementitious compositions of the present invention comprising cationically-modified ethyl hydroxyethyl cellulose or cationically-modified hydroxypropyl methyl cellulose. The reduction in the degree of cement retardation is apparent, compared to the cement retardation of the non-cationic starting cellulose ethers.

### EXAMPLE 7

Cationic Hydroxyethyl Cellulose (Cat-HEC)

Cementitious compositions comprising 1.25 percent and 1.75 percent respectively of a cationically-modified hydroxyethyl cellulose, based on dry cement, are prepared as in Example 1b. The cationically-modified hydroxyethyl cellulose is prepared by the base-catalyzed reaction of hydroxyethyl cellulose with glycidyl trimethylammonium chloride, and is commercially available from Amerchol Corporation under the Trademark UCARE Polymer JR-30M. It has an EO MS (MS_{hydroxyethoxyl}) of 2.1, a Kjeldahl nitrogen content of 1.87 percent (cationic substitution of 0.43), and a viscosity of a 1 weight percent aqueous solution of 1740 mPa·s. The curing time of the cement mixture comprising 1.25 percent of Cat-HEC, based on dry cement, is 11 hours. A cementitious composition comprising 1.75 percent Cat-HEC, based on dry cement, is prepared in the same manner, and the curing time of the cement mixture is also 11 hours.

FIG. 7 illustrates the curing times of cementitious compositions of the present invention comprising 1.25 and 1.75 weight percent respectively of a cationically-modified hydroxyethyl cellulose Cat-HEC in comparison with the curing rate of Portland cement comprising 0 percent of HEC, and with Comparative Example B, a cementitious composition comprising 1.25 weight percent of a non-cationically-modified hydroxyethyl cellulose with the same EO MS (2.1). FIG. 7 illustrates that the curing time of a cementitious composition comprising a cationically-modified hydroxyethyl cellulose is significantly shorter than that of a cementitious composition comprising a corresponding non-modified hydroxyethyl cellulose. FIG. 7 further illustrates that the curing times of the cementitious compositions of the present invention do not vary to a large extent with varying concentrations of the cationically-modified hydroxyethyl cellulose (Cat-HEC).

### COMPARATIVE EXAMPLE H

A cement mixture as in Example 1b is prepared, except that a hydroxyethyl cellulose is used which is commercially available as NATROSOL™ Hi Vis HEC from Aqualon Corporation. This hydroxyethyl cellulose has an EO MS (MS_{hydroxyethoxyl}) of 2.5. The viscosity of a 1 weight percent aqueous solution of this hydroxyethyl cellulose, corrected for volatiles, is 6580 mPa·s. The curing time of the: cement mixture comprising 1.25 percent of hydroxyethyl cellulose, based on dry cement, is 27′ hours.

### COMPARATIVE EXAMPLE I

A cement mixture as in Example 1b is prepared, except that a hydroxyethyl cellulose is used which is commercially available as TYLOSE™ H 30000 from Clariant. This hydroxyethyl cellulose has an EO MS (MS_{hydroxyethoxyl}) of 2. The viscosity of a 1 weight percent aqueous solution of this hydroxyethyl cellulose, corrected for volatiles, is 2000 mPa·s. The curing time of the cement mixture comprising 1.25 percent of hydroxyethyl cellulose, based on dry cement, is 22 hours.

Analysis of Hydroxyethyl Cellulose for Percent Unsubstituted Glucose

A 250 ml single-necked round bottomed flask is charged with 120 ml of 5 percent aqueous sulfuric acid and cooled to 15° C. With swirling, 2.5 g of hydroxyethyl cellulose (HEC), which are weighed to the nearest ±0.1 mg, recorded as “m” and inserted in the formula below, corrected for ash and volatiles, are added to the flask, and the container used for weighing the HEC is rinsed with 20 ml of 5 percent aqueous sulfuric acid. The round bottomed flask is fitted with a reflux condenser and magnetic stirring bar, and with stirring the mixture is vigorously refluxed for 6 hours.

The mixture is then cooled to room temperature and the hydrolyzate is diluted in a volumetric flask with distilled water to 200.00 ml. A 75.00 ml aliquot of this solution is transferred to a 100 ml beaker, and while stirring with a magnetic stirring bar, the pH of the solution is adjusted to 4.0 by adding dilute aqueous ammonium hydroxide and monitoring the pH of the solution using a pH meter. The pH of the mixture should not exceed 5.5.

The partly neutralized solution is transferred to a 100.00 ml volumetric flask and diluted to the mark with distilled water. This diluted solution is subjected to the Trinder glucose analysis described below.

5.00 ml of the Trinder reagent is pipetted into three test tubes and and allowed to equilibrate at 25.0° C. in a water bath. At timed intervals, 25 microliter of distilled water (designated as “blank”), glucose standard (300 mg/dl or 3.00 mg/ml), or the partly neutralized and hydrolyzed HEC solution prepared above is added to the test tubes in the water bath at 25.0° C. Each test tube is incubated for exactly 18 minutes, and the absorbances of the three samples are read on a spectrophotometer at 505 nm. The spectrophotometer should be zeroed against distilled water. The absorbances at 505 nm for the sample (“hec”), blank (“b”), and standard (“s”) are recorded. The percent unsubstituted glucose is calculated from the equation:

$$Percent unsubstituted glucose = \frac{80 \times ( hec - b )}{m \times ( s - b )}$$

The hydroxyethyl cellulose polymers described above in the Examples and Comparative Examples above are subjected to this measurement of unsubstituted glucose, and the results are compiled in Table 1 below. A plot of Portland cement retardation as a function of the unsubstituted glucose concentration in each hydroxyethyl cellulose sample is illustrated by FIG. 9. The data are fitted to a linear regression, which affords an excellent correlation. The percentage of unsubstituted glucose repeat units is a measure of the homogeneity of hydroxyethoxyl substituents; the lower the percentage of unsubstituted glucose repeat units, the more homogeneous the substitution of hydroxyethoxyl substituents on the cellulosic backbone. The effect of the homogeneity of distribution of hydroxyethoxyl substituents of the HEC polymer on cement retardation is clearly apparent. For example, polymer HEC-5 of the present invention, prepared using a two-stage ethoxylation process (EO MS of 2.15) affords a significantly lower percentage of unsubstituted glucose and a correspondingly lower degree of cement retardation than Comparative Example B (EO MS of 2.1), which is prepared by a single stage ethoxylation of cellulose. Similarly, polymer HEC-6 of the present invention, prepared using a two-stage ethoxylation process (EO MS of 2.2) affords a significantly lower percentage of unsubstituted glucose and a correspondingly lower degree of cement retardation than Comparative Example K (EO MS of 2.1), which is prepared by a single stage ethoxylation of cellulose. Thus, the measurement of the percentage of unsubstituted glucose in hydroxyethyl cellulose is a predictive tool for determining the degree of cement retardation.

TABLE 1

| | Cellulose | | | | | |
|---|---|---|---|---|---|---|
| (Comp.) | ether | | Viscosity | Unsubstituted | | Cement |
| Example | description | (MS_{hydroxyethoxyl}) | (mPa · s) | glucose | | retardation |
| A | CELLOSIZE | 2.4 | 4830 | 9.3 | percent | 19 hours |
| | QP-100MH, | | | | | |
| | US origin | | | | | |
| B | CELLOSIZE | 2.1 | 5130 | 15.8 | percent | 27 hours |
| | QP-100MH, | | | | | |
| | Belgium | | | | | |
| | origin | | | | | |
| 1 | HEC-1 | 2.6 | 3300 | 6.7 | percent | 12 hours |
| C | HEC-2 | 1.8 | 2950 | 16.4 | percent | 30 hours |
| D | HEC-3 | 3.6 | 2700 | 5.3 | percent | 13 hours |
| E | HEC-4 | 0.9 | Not | 35.1 | percent | 72 hours |
| | | | measured | | | |
| 2 | HEC-5 | 2.15 | 6100 | 7.9 | percent | 16 hours |
| H | NATROSOL | 2.5 | 6580 | 14.5 | percent | 27 hours |
| | Hi Vis HEC | | | | | |
| I | TYLOSE H | 2 | 2000 | 10.1 | percent | 22 hours |
| | 30000 HEC | | | | | |
| 8 | HEC-6 | 2.2 | 580 | 7.4 | percent | 14 hours |
| K | CELLOSIZE | 2.1 | 366 | 13.2 | percent | 25 hours |
| | QP-300, | | | | | |
| | Belgium | | | | | |
| | origin | | | | | |
| L | CELLOSIZE | 1.4 | 250 | 20.4 | percent | 56 hours |
| | HEC-59, US | | | | | |
| | origin | | | | | |

### EXAMPLE 8

8a) Preparation of Hydroxyethyl Cellulose (HEC-6).

A two liter, glass reactor is charged with 60.00 g of Atisholz™ S 35 wood flock (corrected for volatiles, laboratory cut) and 780.0 g of an azeotropic mixture of isopropyl alcohol and water. The mixture is stirred for one hour while purging the headspace of the reactor with nitrogen to remove any entrained oxygen. The reactor is fitted with a condenser cooled with frozen carbon dioxide to prevent evaporative losses of the diluent and reactants. The slurry is warmed up to 25° C. using a water bath.

After purging for one hour and while holding at 25° C., 31.2 g of 50 percent aqueous sodium hydroxide solution are added to the slurry by syringe. The slurry is stirred for one hour at 25° C., while continuing the nitrogen headspace purge. The molar ratio of sodium hydroxide to cellulose in this first step is 1.05. The nitrogen purge is stopped and the reactor is sealed. A first charge of 27.6 g of ethylene oxide is added to the reactor by syringe. The slurry is heated with a water bath to 75° C. during a heat-up time of 60 minutes. One hour after reaching 75° C., the molar ratio of sodium hydroxide to cellulose of the reaction is adjusted by adding 16.7 g of glacial acetic acid to the reactor, and stirring for 15 minutes is continued. The molar ratio of sodium hydroxide to cellulose for the second step of the reaction is 0.30. A second charge of 30.0 g of ethylene oxide is added to the reactor. The reaction is heated to 80° C. and held at 80° C. for 4 hours and 30 minutes.

At 80° C., 10 ml of a 0.35 percent aqueous solution of hydrogen peroxide is added and subsequently the slurry is cooled to 60° C. and 7.9 g of glacial acetic acid is added by syringe. After stirring for 15 minutes, the polymer is collected by vacuum filtration through a glass funnel. The polymer is washed in the glass funnel three times with 000 ml of an azeotropic mixture of isopropyl alcohol and water at 50° C. The polymer is dried at 70° C., yielding 102.5 g of an off-white solid.

The volatiles content is 4.7 percent, the ash content (calculated as sodium acetate) is 2:6 percent, and EO MS (MS_{hydroxyethoxyl}) is 2.2 as measured according to the modified Zeisel method, as described further above. The Brookfield viscosity of a 2 weight percent aqueous solution of the hydroxyethyl cellulose, corrected for volatiles, is 580 mPa·s. The viscosity is measured using spindle 3 at 60 rpm and at 25° C.

8b) Performance Testing of Hydroxyethyl Cellulose (HEC-6)

Cementitious compositions to perform the needle setting time and fluid loss using the produced HEC-6 are prepared and tested as outlined above. The needle setting time is 7.5 hours and the fluid loss is 36 ml.

A cement mixture as in Example 1b is prepared, except that the hydroxyethyl cellulose polymer HEC-6 is used. The curing time of the cement mixture comprising 1.25 percent of hydroxyethyl cellulose HEC-6, based on dry cement, is 14 hours.

### COMPARATIVE EXAMPLE J

The performance testing as in Example 8b is executed except that no cellulose ether is added to the cementitious formulations. The needle setting time is 3.8 hours and the fluid loss is 595 ml (calculated value, as prescribed in the test method).

### COMPARATIVE EXAMPLE K

The performance testing as in Example 8b is executed except that a hydroxyethyl cellulose is used which is commercial available as CELLOSIZE™ HEC QP-300, made in Belgium by Union Carbide Benelux, a subsidiary of The Dow Chemical Company. This hydroxyethyl cellulose has an EO MS (MS_{hydroxyethoxyl}) of 2.1 and has been manufactured in an aqueous isopropyl diluent. The hydroxyethyl groups have been introduced into the cellulose in a single stage. The Brookfield viscosity of a 2 weight aqueous solution of this hydroxyethyl cellulose, corrected for volatiles, is 366 mPa·s. The needle setting time is 14 hours and the fluid loss is 47 ml.

A cement mixture as in Example 1b is prepared, except that the hydroxyethyl cellulose polymer of comparative Example K is used. The curing time of the cement mixture comprising 1.25 percent of hydroxyethyl cellulose of comparative Example K, based on dry cement, is 25 hours.

### COMPARATIVE EXAMPLE L

The performance testing as in Example 8b is executed except that a hydroxyethyl cellulose is used which is commercial available as CELLOSIZE™ HEC 59, made in the US by Union Carbide Corporation, as subsidiary of The Dow Chemical Company. This hydroxyethyl cellulose has an EO MS (MS_{hydroxyethoxyl}) of 1.4 and has been manufactured in an aqueous acetone/ethanol diluent. The hydroxyethyl groups have been introduced into the cellulose in a single stage. The Brookfield viscosity of a 2 weight aqueous solution of this hydroxyethyl cellulose, corrected for volatiles, is 250 mPa·s. The needle setting time is 13.5 hours and the fluid loss is 41 ml. A cement mixture as in Example 1b is prepared, except that the hydroxyethyl cellulose polymer of comparative Example L is used. The curing time of the cement mixture comprising 1.25 percent of hydroxyethyl cellulose of comparative Example L, based on dry cement, is 56 hours.

Comparing the fluid loss and needle setting time of the cementitious compositions of Example 8, and of Comparative Examples K and L, which comprise a cellulose ether, versus the cementitious composition of Comparative Example J without a cellulose ether, shows that the cellulose ether induces at the same time a longer setting time and a lower fluid loss.

Compared to the Comparative Examples K and L, the hydroxyethyl cellulose HEC-6 of Example 8 induces a similar low fluid loss however the setting time is substantially shorter.

FIG. 8 illustrates the curing time of a cementitious composition of the present invention comprising 1.25 weight percent of a low molecular weight hydroxyethyl cellulose HEC-6 in comparison with two comparative cementitious compositions comprising 1.25 weight percent of a comparative hydroxyethyl cellulose of Comparative Example L, designated as CELLOSIZE™ HEC QP-300 and 1.25 weight percent of a comparative hydroxyethyl cellulose of Comparative Example K, designated as CELLOSIZE™ HEC-59.

### EXAMPLE 9

9a) Preparation of Hydroxyethyl Cellulose (HEC-7)

The same procedure as in Example 8a is used, except that a first charge of 22.8 g of ethylene oxide is added to the reactor and a second charge of 25.2 g of ethylene oxide is added to the reactor. After washing, the polymer is dried at 70° C., yielding 93.0 g of an off-white solid.

The volatiles content is 3.1 percent, the ash content (calculated as sodium acetate) is 1.1 percent, and EO MS (MS_{hydroxyethoxyl}) is 1.8 as measured according to the modified Zeisel method. The Brookfield viscosity of a 2 weight percent aqueous solution of the hydroxyethyl cellulose, corrected for volatiles, is 884 mPa·s. The viscosity is measured sing spindle 3 at 60 rpm and at 25° C.

9b) Performance Testing of Hydroxyethyl Cellulose (HEC-7)

Cementitious compositions to perform the needle setting time and fluid loss using the produced HEC-7 are prepared and tested as outlined above. The needle setting time is 9.0 hours and the fluid loss is 43 ml.

### EXAMPLE 10

10a) Preparation of Hydroxyethyl Cellulose (HEC-8)

The same procedure as in Example 8a is used, except that a first charge of 25.8 g of ethylene oxide is added to the reactor and a second charge of 41.4 g of ethylene oxide is added to the reactor. After washing, the polymer is dried at 70° C., yielding 110.5 g of an off-white solid.

The volatiles content is 10.3 percent, the ash content (calculated as sodium acetate) is 3.1 percent, and EO MS (MS_{hydroxyethoxyl}) is 2.3 as measured according to the modified Zeisel method. The Brookfield viscosity of a 2 weight percent aqueous solution of the hydroxyethyl cellulose, corrected for volatiles, is 384 mPa·s. The viscosity is measured using spindle 3 at 60 rpm and at 25° C.

10b) Performance Testing of Hydroxyethyl Cellulose (HEC-8)

Cementitious compositions to perform the needle setting time and fluid loss using the produced HEC-8 are prepared and tested as outlined above. The needle setting time is 7.17 hours and the fluid loss is 52 ml.

1. A cementitious composition comprising i) a cationically-modified or a secondary or tertiary amino-modified cellulose ether or ii) a cellulose ether comprising a hydroxyethoxyl substituent alone or in combination with one or more other substituents bound to oxygen, wherein the ethylene oxide molar substitution MS_{hydroxyethoxyl} is either from 2.2 to 3.2 and the percentage of unsubstituted anhydroglucose units is up to 8.5% or the ethylene oxide molar substitution MS_{hydroxyethoxyl} is less than 2.2 and the percentage of unsubstituted anhydroglucose units is up to 12%.

2. A cementitious composition comprising
i) a cationically-modified or a secondary or tertiary amino-modified cellulose ether or
ii) a cellulose ether comprising a hydroxyethoxyl substituent alone or in combination with one or more other substituents bound to oxygen, wherein the hydroxyethoxyl substituent has been introduced into the cellulose material in two or more stages.

3. The cementitious composition of claim 1 wherein the cellulose ether i) is selected from the group consisting of hydroxyethyl celluloses, C₁-C₄-alkyl hydroxyethyl celluloses, hydroxy-C₃-4-alkyl hydroxyethyl celluloses, and carboxy-C₁-C₄-alkyl hydroxyethyl celluloses.

4. The cementitious composition of claim 1 wherein the cellulose ether comprises a hydroxyethoxyl substituent alone or in combination with one or more other substituents bound to oxygen, wherein the ethylene oxide molar substitution MS_{hydroxyethoxyl} is up to 3.2 and the percentage of unsubstituted anhydroglucose units is up to 8.5%.

5. The cementitious composition of claim 1 wherein the ethylene oxide molar substitution MS_{hydroxyethoxyl} of the cellulose ether ii) is either from 2.2 to 2.6 and the percentage of unsubstituted anhydroglucose units is up to 8.5% or the ethylene oxide molar substitution MS_{hydroxyethoxyl} is from 1.0 to 2.0 and the percentage of unsubstituted anhydroglucose units is up to 11.5%.

6. The cementitious composition of claim 1 wherein the cellulose ether has a viscosity of from 3000 to 7500 mPa·s, measured as a 1-wt. % aqueous solution at 25° C. using a Brookfield viscometer as described in ASTM D-2364.

7. The cementitious composition of claim 1 wherein the cellulose ether has a viscosity of from 1 to 5000 mPa·s, measured as a 2-wt. % aqueous solution at 25° C. using a Brookfield viscometer as described in ASTM D-2364.

8. The cementitious composition of claim 1 wherein the cellulose ether i) is a cationically-modified or a secondary or tertiary amino-modified hydroxyethyl cellulose.

9. (canceled)

10. A cellulose ether comprising a hydroxyethoxyl substituent alone or in combination with one or more other substituents bound to oxygen, wherein
the ethylene oxide molar substitution MS_{hydroxyethoxyl} is either from 2.2 to 3.2 and the percentage of unsubstituted anhydroglucose units is up to 8.5% or the ethylene oxide molar substitution MS_{hydroxyethoxyl} is less than 2.2 and the percentage of unsubstituted anhydroglucose units is up to 12% and
the viscosity of the cellulose ether is from 3,000 to 10,000 mPa·s, measured as a 1 weight % aqueous solution at 25° C. using a Brookfield LVT viscometer as described in ASTM method D-2364.

11. The cellulose ether of claim 10 wherein the viscosity of the cellulose ether is from 3,000 to 7,500 mPa·s.

12. A cellulose ether comprising a hydroxyethoxyl substituent alone or in combination with one or more other substituents bound to oxygen, wherein
the ethylene oxide molar substitution MS_{hydroxyethoxyl} is either from 2.2 to 3.2 and the percentage of unsubstituted anhydroglucose units is up to 8.5% or the ethylene oxide molar substitution MS_{hydroxyethoxyl} is less than 2.2 and the percentage of unsubstituted anhydroglucose units is up to 12% and
the viscosity of the cellulose ether is from 1 to 5000 mPa·s, measured as a 2 weight % aqueous solution at 25° C. using a Brookfield LVT viscometer as described in ASTM method D-2364.

13. The cellulose ether of claim 12 wherein the viscosity of the cellulose ether is from 1 to 1000 mPa·s.

14. (canceled)

15. The cellulose ether of claim 10 wherein the cellulose ether comprises a hydroxyethoxyl substituent alone or in combination with one or more other substituents bound to oxygen, wherein the ethylene oxide molar substitution MS_{hydroxyethoxyl} is up to 3.2 and the percentage of unsubstituted anhydroglucose units is up to 8.5%.

16. The cellulose ether of claim 10 wherein the ethylene oxide molar substitution MS_{hydroxyethoxyl} of the cellulose ether ii) is either from 2.2 to 2.6 and the percentage of unsubstituted anhydroglucose units is up to 8.5% or the ethylene oxide molar substitution MS_{hydroxyethoxyl} is from 1.0 to 2.0 and the percentage of unsubstituted anhydroglucose units is up to 11.5%.

17. A method of controlling the curing time of a cellulose ether-comprising cementitious composition wherein
i) a cationically-modified or a secondary or tertiary amino-modified cellulose ether or
ii) a cellulose ether comprising a hydroxyethoxyl substituent alone or in combination with one or more other substituents bound to oxygen, wherein the ethylene oxide molar substitution MS_{hydroxyethoxyl} is either from 2.2 to 3.2 and the unsubstituted anhydroglucose units is up to 8.5%, or the ethylene oxide molar substitution MS_{hydroxyethoxyl} is less than 2.2 and the percentage of unsubstituted anhydroglucose units is up to 12%, is incorporated into the cementitious composition.

18. A method of controlling the curing time of a cellulose ether-comprising cementitious composition wherein
i) a cationically-modified or a secondary or tertiary amino-modified cellulose ether or
ii) a cellulose ether comprising a hydroxyethoxyl substituent alone or in combination with one or more other substituents bound to oxygen, wherein the hydroxyethoxyl substituent has been introduced into the cellulose material in two or more stages, is incorporated into the cementitious composition.

19. (canceled)

20. The cementitious composition of claim 1 wherein the cellulose ether has a viscosity of from 100 to 20,000 mPa·s, measured as a 1-wt. % aqueous solution at 25° C. using a Brookfield viscometer as described in ASTM D-2364.

21. The cementitious composition of claim 2 wherein the cellulose ether has a viscosity of from 100 to 20,000 mPa·s, measured as a 1-wt. % aqueous solution at 25° C. using a Brookfield viscometer as described in ASTM D-2364.

22. The cementitious composition of claim 2 wherein the cellulose ether has a viscosity of from 3000 to 7500 mPa·s, measured as a 1-wt. % aqueous solution at 25° C. using a Brookfield viscometer as described in ASTM D-2364.

23. The cementitious composition of claim 2 wherein the cellulose ether has a viscosity of from 1 to 5000 mPa·s, measured as a 2-wt. % aqueous solution at 25° C. using a Brookfield viscometer as described in ASTM D-2364.

24. The cementitious composition of claim 2 wherein the cellulose ether i) is a cationically-modified or a secondary or tertiary amino-modified hydroxyethyl cellulose.

25. The cellulose ether of claim 12 wherein the cellulose ether comprises a hydroxyethoxyl substituent alone or in combination with one or more other substituents bound to oxygen, wherein the ethylene oxide molar substitution MS_{hydroxyethoxyl} is up to 3.2 and the percentage of unsubstituted anhydroglucose units is up to 8.5%.

26. The cellulose ether of claim 12 wherein the ethylene oxide molar substitution MS_{hydroxyethoxyl} of the cellulose ether ii) is either from 2.2 to 2.6 and the percentage of unsubstituted anhydroglucose units is up to 8.5% or the ethylene oxide molar substitution MS_{hydroxyethoxyl} is from 1.0 to 2.0 and the percentage of unsubstituted anhydroglucose units is up to 11.5%.
